(19) United States
(12) Patent Application Publication
(10) Pub. No.: US 2006/0283487 A1
(43) Pub. Date: Dec. 21, 2006

(54) Razor cleaning device

(76) Inventor: Richard Grabowski, New Britain, CT (US)

Correspondence Address: TED PAULDING, 10 PENWOOD LA., WETHERSFIELD, CT, 06109, US

(21) Appl. No.: 11/156,379

(22) Filed: Jun. 15, 2005

(51) Int. Cl. B08B 3/00; B08B 3/12

(52) U.S. Cl. 134/184; 134/198; 134/135

(57) ABSTRACT

A cleaning device for small utensils such as razors comprising a housing and a supply of water or other cleaning fluid. In one form a motor and pump pressurize the water and in another residential pressure is employed. A cleaning element takes the form of a coil of tubing with radially inwardly directed orifices. A splash restrictor is disposed in an access opening for the cleaning element.

### BACKGROUND OF THE INVENTION

The marketplace is substantially devoid of cleaning devices for small utensils such as manual razors, tooth brushes, nail brushes etc. Accordingly, it is the general object of the present invention to provide such a cleaning device which is of simple construction, well adapted to manufacture at economic advantage, marketable at a reasonable price, and which is yet highly efficient and durable over a long life in operation.

### SUMMARY OF THE INVENTION

In accordance with the present invention and in fulfillment of the foregoing general object, a cleaning device for small utensils has a housing and a supply of water or other cleaning fluid under pressure. A tubular cleaning element in the form of a hollow cylinder is connected with the pressurized water or other fluid and has a plurality of small orifices directed radially inwardly to provide jets of water or cleaning fluid An access opening in the housing axially adjacent the central opening of the cleaning element provides for ready entry and removal of a razor or the like to be cleaned. Finally, a splash restricting member disposed in the access opening permits free entry of the razor and at the same time prevents unwanted splashing of the water or cleaning fluid outwardly through the opening. The pressurizing means preferably comprises a small electric motor and pump but in an alternative embodiment residential water pressure is employed by tapping into a convenient conduit

### DRAWING DESCRIPTION

FIG. 1 is a somewhat schematic vertical section through the cleaning device of the invention,

FIG. 2 is a top view of a splash restricting member forming a part of the device, and

FIG. 3 is a schematic view of a alternative embodiment of the invention.

### DESCRIPTION OF PREFERRED EMBODIMENTS

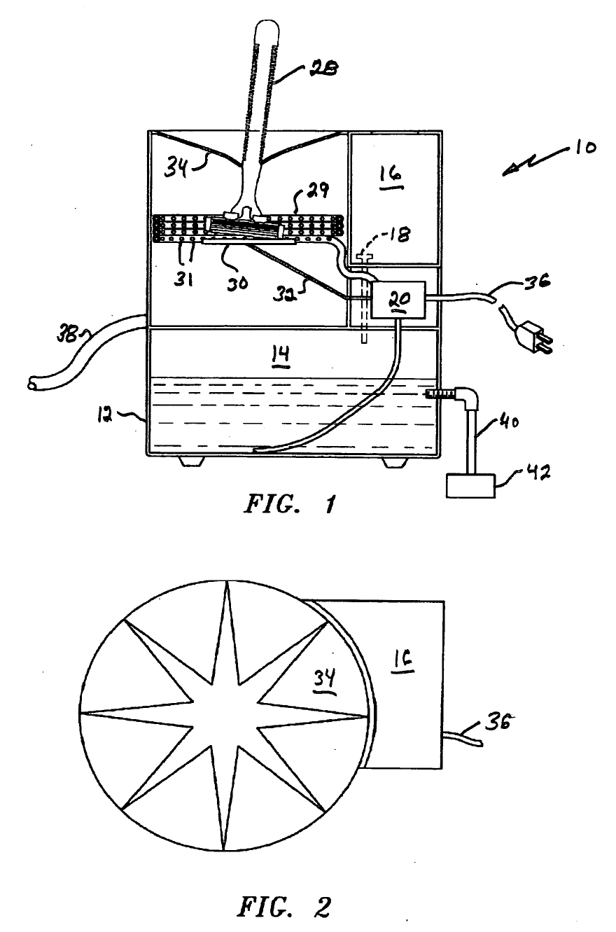

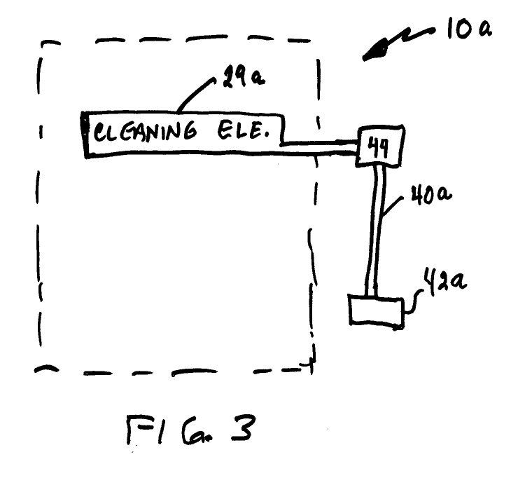

Referring initially to FIG. 1, a cleaning device constructed in accordance with the present invention is indicated generally at 10. A base portion of a housing 12 comprises a main reservoir or sump 14 for storing water or other cleaning fluid. A removably mounted filler reservoir 16 may be readily transported to a faucet or the like, filled, and then returned to the position shown. An automatic release valve 18 allows the water to drain to the main reservoir or sump 14 as needed.

Electric motor and pump unit 20 has an associated supply conduit 22 and a discharge conduit 24 which extends to a cleaning element 29. The cleaning element 29 has a hollow cylindrical configuration and is preferably formed of a coil of metallic or plastic tubing. The coil has a plurality of turns arranged about a vertical axis and has a plurality of small orifices 31,31 directed radially inwardly. The orifices collectively provide a highly effective high pressure shower of water or other cleaning fluid for a small utensil such as a manual razor. As is well known, manual razors are subject to stubborn collections of whiskers and skin etc in the narrow longitudinally elongated spaces behind their blades.

An on-off switch for the motor may take the form of a small platform-like actuator 30 engageable by the razor. An actuator arm 32 extends from the platform 30 to the motor-pump unit 20.

Disposed above and axially adjacent the coil opening is a splash restricting member 34 in the form of an elastomeric disc with a centrally located star shaped opening 36. The opening 36 provides for ready entry of an object to be cleaned such as razor 28 and at the same time prevents unwanted debris from entering the cleaning chamber and water from escaping outwardly.

Optionally, a filler tube 40 may be provided with a tap in a supply conduit 42 preferably in the form of a piercing valve, not shown. Thus, the reservoir 14 can be supplied with water and the filler reservoir 16 dispensed with.

In an alternative form of the invention, the motor-pump unit may be replaced by an on-off valve 44, FIG. 3, and arm 32 of the actuator platform 30 connected thereto for on-off operation. Tap 42 is preferably of the piercing type and may be located in any convenient residential conduit.

As will be apparent from the foregoing, The cleaning device of the invention is of desireably simple construction conducive to efficient operation over a long service life, manufacture at economic advantage, and retail sale at a reasonable price.

1. A cleaning device for small utensils such as manual razors and the like; said device comprising a housing and a supply of water or other cleaning fluid, a means for pressurizing the water or fluid, a tubular cleaning element in the configuration of a coil having a plurality of turns and which is connected for a supply of water or cleaning fluid with said pressurizing means and water supply, said cleaning element having a plurality of small openings directed radially inwardly to provide jets of water or cleaning fluid, an access opening in the housing axially adjacent the central opening of the coil for the entry and removal of a razor or the like to be cleaned, and a splash restricting element disposed in said opening and adapted to permit free entry of the razor and at the same time prevent splashing of the cleaning water or fluid outwardly through the opening.

2. A cleaning device as set forth in claim 1 wherein the supply of water or cleaning fluid is a reservoir.

3. A cleaning device as set forth in claim 1 wherein the supply of water is a tap into the residential water supply system.

4. A cleaning device as set forth in claim 3 wherein the tap is of the piercing type.

5. A cleaning device as set forth in claim 2 wherein the pressurizing means takes the form of a small electric motor and pump connected between the reservoir and the cleaning element

6. A cleaning device as set forth in claim 5 wherein an actuator for the motor and pump is provided in the form of a movable element engageable by the razor or other utensil at an end of the coil opposite the access opening.

7. A cleaning device as set forth in claim 3 wherein an on-off valve is provided between the tap and the cleaning element.

8. A cleaning device as set forth in claim 3 wherein the tap is connected to the aforesaid reservoir rather than the cleaning element.

9. A cleaning device as set forth in claim 2 wherein a small secondary reservoir is provided and is adapted to be readily removed from the housing transported to a water faucet and returned to the housing.

10. A cleaning device as set forth in claim 9 wherein the secondary reservoir is disposed above and is provided with a filler tube which communicates with the first mentioned reservoir for automatically replenishing the water or cleaning fluid supply in the latter.
